(19) United States
(12) Patent Application Publication
(10) Pub. No.: US 2025/0390012 A1
(43) Pub. Date: Dec. 25, 2025

(54) DISPLAY APPARATUS

(71) Applicant: SAMSUNG ELECTRONICS CO., LTD., Suwon-si (KR)

(72) Inventors: Hoseok WEY, Suwon-si (KR); Jongbae KIM, Suwon-si (KR); Liam KELLY, Suwon-si (KR)

(73) Assignee: SAMSUNG ELECTRONICS CO., LTD., Suwon-si (KR)

(21) Appl. No.: 19/313,186

(22) Filed: Aug. 28, 2025

Related U.S. Application Data
(63) Continuation of application No. PCT/KR2024/000383, filed on Jan. 9, 2024.

(30) Foreign Application Priority Data
Mar. 8, 2023 (KR) 10-2023-0030432

(51) Int. Cl. G03B 31/00; G03B 21/14; G03B 29/00

(52) U.S. Cl. CPC G03B 31/00; G03B 21/145; G03B 29/00

(57) ABSTRACT

A display apparatus includes: a case; a projector disposed in the case and configured to output video content; and a speaker set disposed between the case and the projector module, and configured to output audio content, wherein the speaker set includes a tweeter and a full-range speaker adjacent to the tweeter.

### CROSS-REFERENCE TO RELATED APPLICATIONS

This application is a bypass continuation application of International Application No. PCT/KR2024/000383, filed on Jan. 9, 2024, which claims priority to Korean Patent Application No. 10-2023-0030432, filed on Mar. 8, 2023, in the Korean Intellectual Property Office, the disclosures of which are incorporated by reference herein in their entireties.

### BACKGROUND

### 1. Field

The disclosure relates to a display apparatus.

### 2. Description of Related Art

The metaverse is being presented as a paradigm that creates value in various fields, such as society, culture, art, shopping, education, and gaming, where people and objects interact in a space where the virtual and the real converge.

A user primarily uses the metaverse through a head-mounted display, headphones, and the like. However, a plurality of users cannot experience the metaverse simultaneously.

Accordingly, the development of display apparatus such as a projector that outputs an image in a space using the metaverse is being actively carried out so that an image related to the metaverse may be output to a plurality of people simultaneously.

### SUMMARY

Provided is a display apparatus that may output three-dimensional sound from a plurality of directions.

Additional aspects will be set forth in part in the description which follows and, in part, will be apparent from the description, or may be learned by practice of the presented embodiments.

According to an aspect of the disclosure, a display apparatus includes: a case; a projector disposed in the case and configured to output video content; and a speaker set disposed between the case and the projector, and configured to output audio content, wherein the speaker set includes at least one tweeter and at least one full-range speaker adjacent to the at least one tweeter.

The display apparatus may further include a plurality of speaker sets including the speaker set, and at least two speaker sets of the plurality of speaker sets may be disposed symmetrically with respect to the projector.

Each of the at least one tweeter and the at least one full-range speaker may include: a sound generator configured to generate sound; and a guide tube including a plurality of radiation holes configured to output the sound.

The plurality of radiation holes of the guide tube of the at least one tweeter may be arranged along a longitudinal direction of the guide tube of the at least one tweeter, and the plurality of radiation holes of the guide tube of the at least one full-range speaker may be arranged along a longitudinal direction of the guide tube of the at least one full-range speaker.

The at least one full-range speaker and the at least one tweeter may be disposed so that the plurality of radiation holes of the guide tube of the at least one full-range speaker may be arranged in a same direction as the plurality of radiation holes of the guide tube of the at least one tweeter.

The at least one tweeter may include a first tweeter and a second tweeter, the at least on full-range speaker may include a first full-range speaker and a second full-range speaker, the first tweeter and the first full-range speaker may be disposed so that the plurality of radiation holes of the guide tube of the first full-range speaker may be arranged in the same direction as the plurality of radiation holes of the guide tube of the first tweeter, the second tweeter may be disposed so that the plurality of radiation holes of the guide tube of the second tweeter is arranged in a different direction from the plurality of radiation holes of the guide tube of the first tweeter, and the second full-range speaker may be disposed so that the plurality of radiation holes of the guide tube of the second full-range speaker is arranged in a same direction as the plurality of radiation holes of the guide tube of the second tweeter.

The second tweeter and the second full-range speaker may be disposed so that the plurality of radiation holes of the guide tube of the second tweeter and the plurality of radiation holes of the guide tube of the second full-range speaker is arranged in a direction opposite to the plurality of radiation holes of the guide tube of the first tweeter.

The at least one tweeter may include a first tweeter and a second tweeter, and the second tweeter is configured to output the sound in a direction opposite to a sound output direction of the first tweeter.

The display apparatus may further include a plurality of sub speakers positioned on an outer surface of the case.

The plurality of sub speakers may be disposed on a virtual plane.

The plurality of sub speakers may be disposed on a plurality of virtual planes, and the plurality of virtual planes intersect each other.

According to an aspect of the disclosure, a display apparatus includes: a case; a projector disposed in the case and configured to output video content; a speaker set disposed between the case and the projector and configured to output sound associated with audio content; and a plurality of sub speakers positioned on an outer surface of the case, wherein the speaker set may include a tweeter and a full-range speaker adjacent to the tweeter, wherein the plurality of sub speakers is disposed on a plurality of virtual planes, and wherein the plurality of virtual planes intersect each other.

Each of the tweeter and the full-range speaker may include: a sound generator configured to generate sound; and a guide tube including a plurality of radiation holes configured to output the sound.

According to an aspect of the disclosure, a display apparatus includes: a case; a projector disposed in the case and configured to output video content; a speaker set disposed between the case and the projector, and configured to output sound associated with audio content; at least one sub speaker positioned on an outer surface of the case; and a processor configured to perform signal processing on the audio content, separate the processed audio content into a first signal with a fixed sound image localization and a second signal with a moving sound image localization, and control the speaker set and the at least one sub speaker based on the first signal and the second signal.

The processor may be further configured to control the speaker set to output the sound based on the first signal.

The display apparatus may further included an optical sensor portion configured to obtain spatial information, and the processor may be configured to determine a plurality of points at which the sound arrives within a space based on the spatial information, and control the speaker set to output the sound to the plurality of points.

The speaker set may include a tweeter and a full-range speaker adjacent to the tweeter, wherein the tweeter may include a plurality of radiation holes, and the full-range speaker may include a plurality of radiation holes.

The at least one sub speaker may be disposed on a virtual plane.

The at least one sub speaker may include a plurality of sub speakers may be disposed on a plurality of virtual planes, and the plurality of virtual planes intersect each other.

The output sound may be three-dimensional sound.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram illustrating an example of an exterior of a display apparatus according to an embodiment from the front;

FIG. 2 is a diagram illustrating that a display apparatus according to an embodiment outputs an image;

FIG. 3 is a diagram illustrating an internal configuration of a display apparatus according to an embodiment;

FIG. 4 is a diagram illustrating a projector of a display apparatus according to an embodiment;

FIG. 5 is a diagram illustrating an interior of a projector of a display apparatus according to an embodiment;

FIG. 6 is a diagram illustrating a speaker set of a display apparatus according to an embodiment;

FIG. 7 is a cross-sectional view of a tweeter;

FIG. 8 is a cross-sectional view of a full-range speaker;

FIGS. 9A, 9B, and 9C are diagrams illustrating a plurality of tweeters and a plurality of full-range speakers constituting a speaker set of a display apparatus according to an embodiment;

FIG. 10 is a diagram illustrating positions of sub speakers of a display apparatus according to an embodiment;

FIG. 11 is a control block diagram of a display apparatus according to an embodiment;

FIG. 12 is a flowchart illustrating a method for controlling a display apparatus according to an embodiment; and

FIG. 13 is a diagram illustrating that a processor of a display apparatus according to an embodiment determines a sound output position.

### DETAILED DESCRIPTION

Various embodiments and the terms used therein are not intended to limit the technology disclosed herein to specific forms, and the disclosure should be understood to include various modifications, equivalents, and/or alternatives to the corresponding embodiments.

In describing the drawings, like reference numerals refer to like elements throughout the specification.

The singular form of a noun corresponding to an item may include one or more of the items unless clearly indicated otherwise in a related context.

In the disclosure, phrases, such as “A or B”, “at least one of A and B”, “at least one of A or B”, “A, B or C”, “at least one of A, B and C”, and “at least one of A, B, or C” may include any one or all possible combinations of the items listed together in the corresponding phrase among the phrases.

As used herein, the terms “1st” or “first” and “2nd” or “second” may use corresponding components regardless of importance or order and are used to distinguish one component from another without limiting the components.

When it is said that one (e.g., first) component is “coupled” or “connected” to another (e.g., second) component, with or without the terms “functionally” or “communicatively”, it means that one component can be connected to the other component directly (e.g., by wire), wirelessly, or through a third component.

It will be understood that when the terms “includes,” “comprises,” “including,” and/or “comprising,” when used in this specification, specify the presence of stated features, figures, steps, operations, components, members, or combinations thereof, but do not preclude the presence or addition of one or more other features, figures, steps, operations, components, members, or combinations thereof.

An expression that one component is “connected”, “coupled”, “supported”, or “in contact” with another component includes a case in which the components are directly “connected”, “coupled”, “supported”, or “in contact” with each other and a case in which the components are indirectly “connected”, “coupled”, “supported”, or “in contact” with each other through a third component.

It will be understood that when one component is referred to as being “on” another component, it can be directly on the other component or intervening components may also be present.

The term “and/or” includes any and all combinations of one or more of a plurality of associated listed items.

The terms “up and down direction (vertical direction),” “lower” “front and back (forward and backward),” etc., used in the following description are defined based on the drawings, and the shape and position of each component are not limited by these terms.

Hereinafter, embodiments will be described in detail with reference to the accompanying drawings.

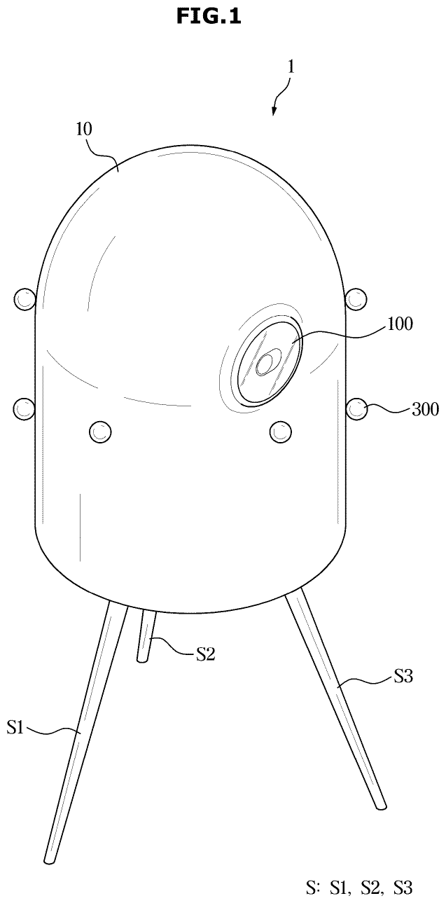

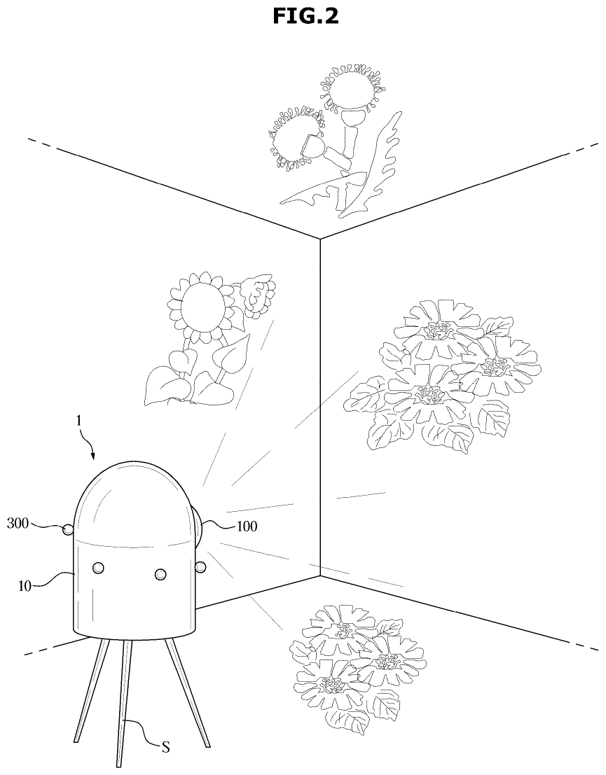

FIG. 1 is a diagram illustrating an example of an exterior of a display apparatus according to an embodiment from the front. FIG. 2 is a diagram illustrating that a display apparatus according to an embodiment outputs an image.

A display apparatus 1 is a device that may process a video signal received from an external device and visually display the processed video. In an embodiment to be described below, a case where the display apparatus 1 is a projector that outputs an image to a space where the display apparatus 1 is located will be described as an example, but the type of the display apparatus 1 according to an embodiment is not limited thereto. For example, any device that processes and visually displays an image, such as a mobile electronic device such as a personal digital assistant (PDA), a smartphone, or a laptop computer, or a computer, may be the display apparatus 1, and the type thereof is not limited.

The display apparatus 1 may receive a video signal and an audio signal from various content sources, and may output video content and audio content corresponding to the received video signal and audio signal. For example, the display apparatus 1 may receive content from an external device such as a digital versatile disc (DVD) player, a game console, or a set-top box, or receive content from a content providing server through the Internet.

Referring to the example of FIG. 1, the display apparatus 1 may include a case 10 that forms an exterior of the display apparatus 1 and accommodates various components constituting the display apparatus 1.

A projector 100 that outputs video content may be disposed on a front side of the case 10. In an embodiment, a direction in which the projector 100 is exposed to an external environment is defined as a front side, and an opposite direction thereof is defined as a rear side.

In FIG. 1, a case where the case 10 is supported by a plurality of stands S1, S2, and S3 and is disposed on a horizontal plane is illustrated as an example. However, this is only an example of the display apparatus 1, and the case 10 and a rotating body may be connected and the display apparatus 1 may be implemented in a rotating form.

In addition, in FIG. 1, sub speakers 300 disposed on an outer surface of the case 10 are illustrated as an example. However, this is only an example of the display apparatus 1, and the sub speakers 300 may be disposed only on an inner surface or may be disposed on both the inner surface and the outer surface.

According to an example of FIG. 2, the display apparatus 1 may output video content to a space where the display apparatus 1 is located. This output is not limited a single plane.

Specifically, the display apparatus 1 may output video content to an upper side, a lower side, a right side, a left side, a front side, and a rear side of the space where the display apparatus 1 is located. In an embodiment, a direction corresponding to a side formed by the stand S and the space where the display apparatus 1 is located is defined as a lower side, an opposite direction thereof is defined as an upper side, and a right side and a left side are defined based on the front side.

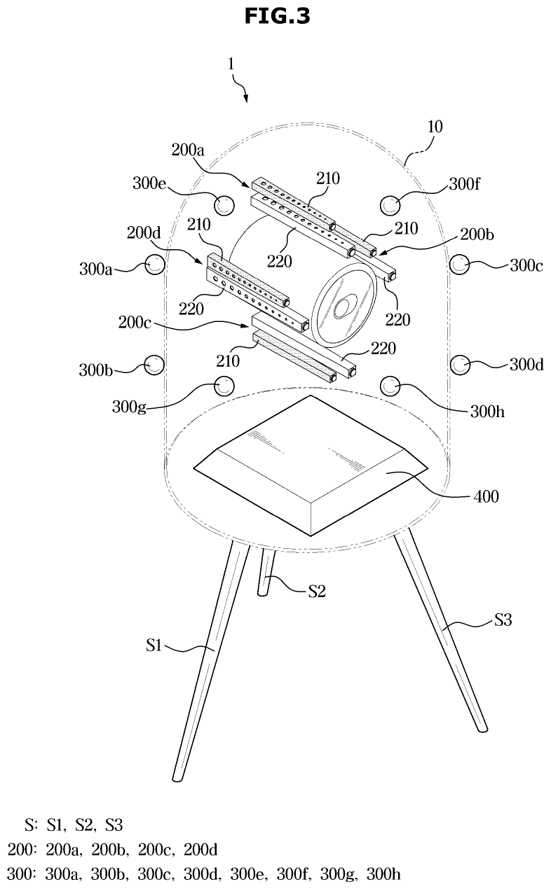

FIG. 3 is a diagram illustrating an internal configuration of the display apparatus 1 according to an embodiment.

The display apparatus 1 may include the case 10, the projector 100, a speaker set 200, sub speakers 300, and a woofer speaker 400.

The case 10 may form an exterior of the display apparatus 1, and may accommodate components of the display apparatus 1, such as the projector 100, a plurality of speaker sets 200, a plurality of sub speakers 300, and the woofer speaker 400.

The case 10 may have a cylindrical shape topped with a half dome to accommodate the components of the display apparatus 1. However, the shape of the case 10 is not limited to the above-described example, and may have various three-dimensional structures for accommodating the components of the display apparatus 1, such as the projector 100, the speaker set 200, and the like. For example, the case 10 may have a cylindrical shape.

The projector 100 may be located in the center of the inside of the case 10 to output video content.

The speaker set 200 may include a tweeter 210 and a full-range speaker 220. Specifically, the tweeter 210 and the full-range speaker 220 may be disposed adjacent to each other.

The tweeter 210 refers to a speaker that outputs content sound (sound) in a high-frequency band (e.g., a band exceeding 3,000 Hz), and the full-range speaker 220 refers to a speaker that outputs content sound in a frequency band excluding a low-frequency band (e.g., 3,000 Hz or less).

A plurality of speaker sets 200 may be provided. For example, the speaker set 200 may include a first speaker set 200a, a second speaker set 200b, a third speaker set 200c, and a fourth speaker set 200d.

The plurality of speaker sets 200 may be disposed symmetrically with respect to the projector 100 to output sound. For example, the first speaker set 200a and the third speaker set 200c may be disposed symmetrically with respect to the projector 100, and the second speaker set 200b and the fourth speaker set 200d may be disposed symmetrically with respect to the projector 100. However, the arrangement of the plurality of speaker sets 200 is not limited to the above-described example and may include any arrangement for outputting sound. For example, the plurality of speaker sets 200 may be arranged in a single column on one side of the projector 100.

The sub speaker 300 refers to a speaker unit that outputs sound to assist the speaker set 200. For example, the sub speaker 300 may output sound that forms a sound field.

A plurality of sub speakers 300 may be provided. For example, the sub speaker 300 may include a first sub speaker 300a, a second sub speaker 300b, a third sub speaker 300c, a fourth sub speaker 300d, a fifth sub speaker 300e, a sixth sub speaker 300f, a seventh sub speaker 300g, and an eighth sub speaker 300h.

The plurality of sub speakers 300 may be disposed symmetrically with respect to the projector 100 to output sound. In addition, as will be described below, the plurality of sub speakers 300 may be located on a plurality of virtual planes, and the plurality of virtual planes may intersect each other.

The woofer speaker 400 may be located at a lower portion of the case 10 to output content sound in a low-frequency band (e.g., a band of 3,000 Hz or less).

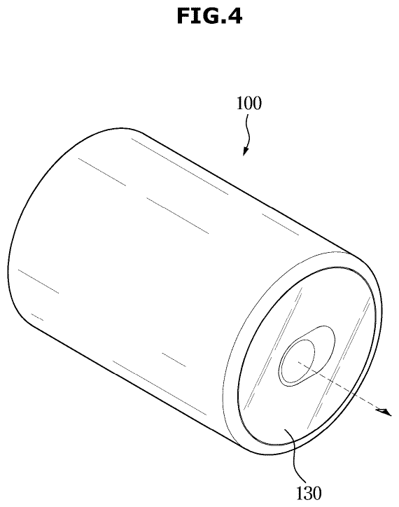

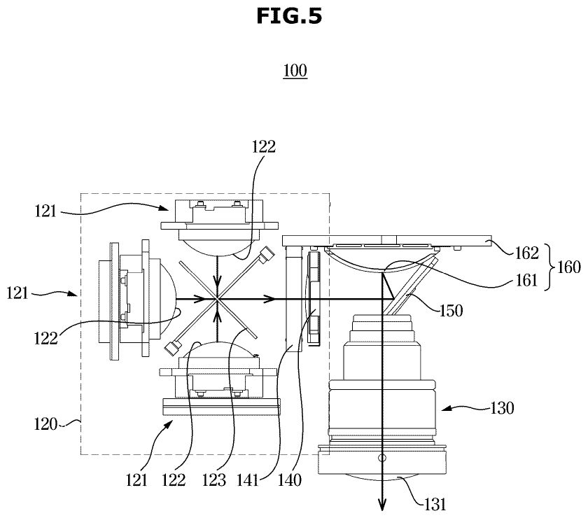

FIG. 4 is a diagram illustrating a projector of a display apparatus according to an embodiment. FIG. 5 is a diagram illustrating an interior of a projector of a display apparatus according to an embodiment.

The projector (or projector module) 100 may output an image to a space where the display apparatus 1 is located. For example, the projector 100 may output video content to an upper side, a lower side, a right side, a left side, a front side, and a rear side of the space where the display apparatus 1 is located, and may also output video content to only a part of the upper side, the lower side, the right side, the left side, and the rear side of the space where the display apparatus 1 is located.

To this end, the projector 100 may include an illumination system 120 that generate light and a projection system 130. The illumination system 120 refers to an optical system including optical components from a light source 121 to a display element 162. The illumination system 120 may include the light source 121.

The light source 121 may be configured as a light emitter that emits Red (R), Green (G), and Blue (B) light. The light emitter may be configured as a light emitting diode (LED). Here, the light source 121 may emit white light, and in this case, a color separation means is additionally configured to separate the white light into R, G, and B light.

The illumination system 120 may further include a collimator lens 122, a filter 123, a fly-eye lens 141, and a condenser lens 140. The collimator lens 122 may be located in a direction in which light is emitted from the light source 121. The collimator lens 122 functions to collect light emitted from the light source 121. Light passing through the collimator lens 122 may then pass through the filter 123, the fly-eye lens 141, and the condenser lens 140. Through the above process, the light may be homogenized and focused.

The projector 100 may further include a refractive system 150 and an image system 160.

The refractive system 150 may reflect the light emitted from the illumination system 120 and proceed the light to the image system 160. In this instance, the refractive system 150 may be configured using a volume holographic mirror. The refractive system 150 may have a flat mirror shape.

The light reflected through the refractive system 150 may proceed to the image system 160. The image system 160 may convert an electrical image signal into an optical image using a display module such as a transmissive liquid crystal display or a digital micromirror device (DMD). Because the image system 160 may not generate light itself, the image system 160 may form a projection image by receiving the light emitted from the illumination system 120.

The image system 160 may include the display element 162 including a display module and a projection lens 161 that collects light.

The light through the image system 160 may be projected onto a screen through the projection system 130. The projection system 130 includes a projection lens 161 that magnifies the projection image emitted from the image system 160 and projects the image on the screen. The projection system 130 may be installed to be movable forward and backward in a direction of travel of the projection image to adjust a focus depending on a distance from the screen. Through the above, the image projected onto the screen may be clearly adjusted.

The illumination system 120 may emit light in a direction perpendicular to the direction of travel of the projection image at a side portion between the image system 160 and the projection system 130. In other words, the light beam incident on the refractive system 150 may travel perpendicular to the direction of travel of the projection image. The light beam emitted from the illumination system 120 is incident perpendicular to the refractive system 150, but the refractive system 150 may reflect the light toward the image system 160.

The image system 160 may form the projection image using the light provided through the refractive system 150 and proceed to the projection system 130. The projection image may proceed perpendicular to the direction of travel of the light emitted from the illumination system 120.

The projector 100 may include a heat dissipation fan 170 and a heat dissipation fin 171 to dissipate heat generated inside the display apparatus 1 to the exterior of the display apparatus 1.

With the above configuration, the projector 100 may output video content by projecting the projection image. According to an embodiment, by variously adjusting the arrangement of the refractive system 150, the projector 100 may output video content to the space where the display apparatus 1 is located.

The projector 100 may have a cylindrical shape to accommodate the above components. However, the shape of the case 10 is not limited to the above-described example, and may have any shape for accommodating the above components of the projector 100. For example, the case 10 may have a spherical shape.

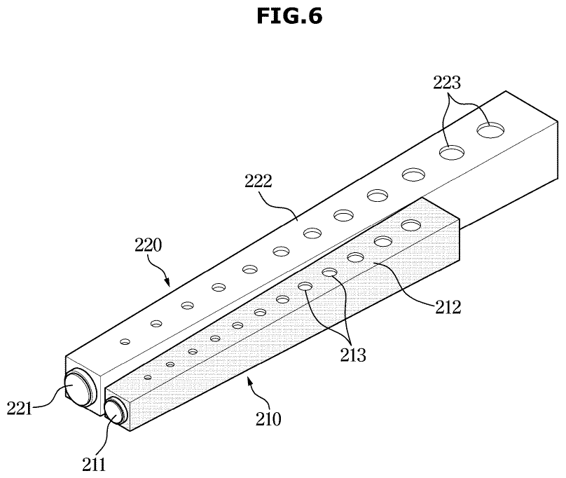

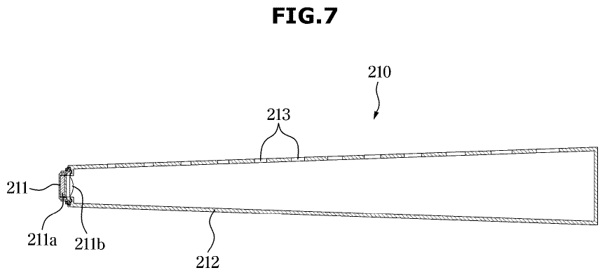

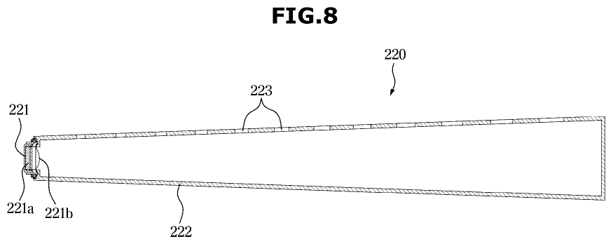

FIG. 6 is a diagram illustrating the speaker set 200 of the display apparatus 1 according to an embodiment. FIG. 7 is a cross-sectional view of the tweeter 210. FIG. 8 is a cross-sectional view of the full-range speaker 220.

Referring to FIG. 6, the tweeter 210 and the full-range speaker 220 may be disposed adjacently, and the tweeter 210 and the full-range speaker 220 may be disposed in the same direction. Specifically, radiation holes of the full-range speaker 220 may be disposed in the same direction as radiation holes of the tweeter 210.

The tweeter 210 includes a sound generator 211 that generates sound, and a guide tube 212 that is connected to the sound generator 211 and outputs sound.

The guide tube 212 includes a plurality of radiation holes 213 arranged on one side surface thereof along a longitudinal direction of the guide tube 212 to allow sound to be radiated to the outside. In the embodiment, the plurality of radiation holes 213 are spaced apart from each other at a constant interval.

The plurality of radiation holes 213, each having a circular shape, are formed with their sizes increasing from one end side of the guide tube 212 where the sound generator 211 is located to the other end side of the guide tube 212. However, the shape of the radiation hole is not limited thereto, and may have any shape for outputting sound. For example, the radiation hole may have a rectangular shape.

In FIG. 6, a case where an internal cross-sectional area of the guide tube 212 continuously and gradually increases in a direction away from the sound generator 211 is illustrated as an example. However, the internal cross-sectional area of the guide tube 212 may continuously and gradually decrease in a direction away from the sound generator 211 or remain constant.

The sound generated from the sound generator 211 may radiate to the outside through each of the plurality of radiation holes 213 while passing through the guide tube 212. Because sound is a sound wave that propagates through air as a medium due to changes in pressure, the sounds radiated with a time difference through the plurality of radiation holes 213 linearly arranged on the guide tube 212 interfere with each other destructively and constructively. As a result, in the process of the sounds interfering with each other, the sounds exhibit directivity in a direction corresponding to the longitudinal direction of the guide tube 212.

For example, the tweeter 210 according to the embodiment operates as a directional speaker due to the structure of the guide tube 212 in which the plurality of radiation holes 213 are formed.

The full-range speaker 220 includes a sound generator 221 that generates sound, and a guide tube 222 that is connected to the sound generator 221 and outputs sound. The guide tube 222 includes a plurality of radiation holes 223 arranged on one side surface thereof along a longitudinal direction of the guide tube 222 to allow sound to be radiated to the outside.

The full-range speaker 220 has the same principle and main configuration as the tweeter 210 to operate as a directional speaker.

However, the guide tube 222 of the full-range speaker 220 may be longer than the guide tube 212 of the tweeter 210 in order to output sound of a relatively longer wavelength than the sound that is output from the tweeter 210.

As shown in FIG. 7, the sound generator 211 of the tweeter 210 may include an electromagnet 211a that receives an electrical signal to generate a magnetic force, and a diaphragm 211b that vibrates by the electromagnet 211a to generate sound. A volume of the sound generator 211 of the tweeter 210 may be smaller than that of the sound generator 221 of the full-range speaker 220 in order to output a high frequency.

As shown in FIG. 8, the sound generator 221 of the full-range speaker 220 may also include an electromagnet 221a that receives an electrical signal to generate a magnetic force, and a diaphragm 221b that vibrates by the electromagnet 221a to generate sound.

In FIG. 6, the speaker set 200 including a tweeter 210 and a full-range speaker 220 is illustrated as an example, but the speaker set 200 may include a plurality of tweeters 210 and a plurality of full-range speakers 220.

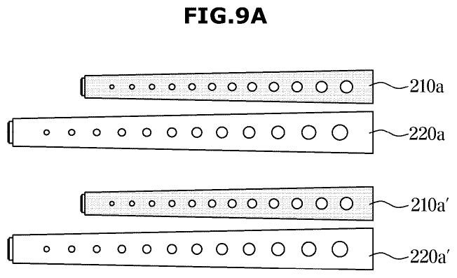

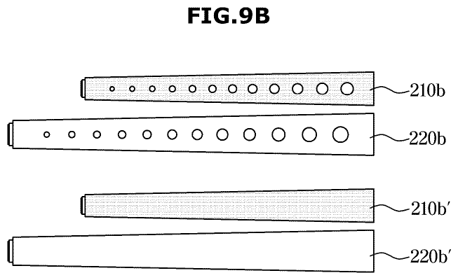

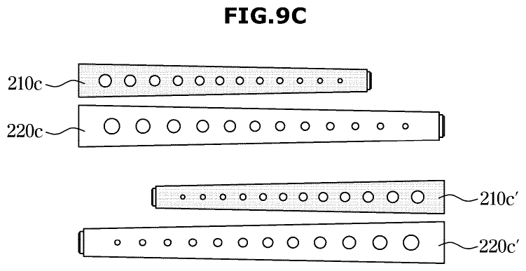

In a case where the speaker set 200 includes a plurality of tweeters 210 and a plurality of full-range speakers 220, an arrangement of the tweeters 210 and the full-range speakers 220 is described with reference to FIG. 9.

FIGS. 9A, 9B, and 9C are diagrams illustrating a plurality of tweeters and a plurality of full-range speakers constituting a speaker set of a display apparatus according to an embodiment.

FIGS. 9A, 9B, and 9C illustrate examples of a speaker set 200 including two tweeters 210 and two full-range speakers 220 disposed adjacent thereto. In FIGS. 9A, 9B, and 9C, the two tweeters 210 and the two full-range speakers 220 are illustrated as an example, but one speaker set 200 may include three or more tweeters 210 and three or more full-range speakers 220 adjacent thereto.

As described above, radiation holes of the full-range speaker 220 disposed adjacent to the tweeter 210 may be arranged in the same direction as radiation holes of the tweeter 210.

FIG. 9A illustrates a first tweeter 210a and a first full-range speaker 220a which are disposed adjacent thereto, and a second tweeter 210a′ and a second full-range speaker 220a′ which are disposed adjacent thereto.

Referring to FIG. 9A, radiation holes of the second tweeter 210a′ may be arranged in the same direction as radiation holes of the first tweeter 210a. Accordingly, radiation holes of the first full-range speaker 220a and the second full-range speaker 220a′ may be arranged in the same direction as the radiation holes of the first tweeter 210a. Because the plurality of speakers may output directional sound in the same direction, more three-dimensional sound may be output.

FIG. 9B illustrates a third tweeter 210b and a third full-range speaker 220b which are disposed adjacent thereto, and a fourth tweeter 210b′ and a fourth full-range speaker 220b′ which are disposed adjacent thereto.

Referring to FIG. 9B, radiation holes of the fourth tweeter 210b′ may be arranged in a different direction from radiation holes of the third tweeter 210b. Accordingly, radiation holes of the fourth full-range speaker 220b′ may be arranged in a different direction from radiation holes of the third full-range speaker 220b.

Specifically, the radiation holes of the fourth tweeter 210b′ and the fourth full-range speaker 220b′ may be arranged in a direction opposite to the radiation holes of the third tweeter 210b and the third full-range speaker 220b. By arranging the direction of the radiation holes from which sound is output differently, more three-dimensional sound may be output.

FIG. 9C illustrates a fifth tweeter 210c and a fifth full-range speaker 220c which are disposed adjacent thereto, and a sixth tweeter 210c′ and a sixth full-range speaker 220c′ which are disposed adjacent thereto.

Referring to FIG. 9C, a sound generator of the sixth tweeter 210c′ may be disposed in a different direction from a position of a sound generator of the fifth tweeter 210c. Accordingly, a sound generator of the sixth full-range speaker 220c′ may be disposed in a different direction from a position of a sound generator of the fifth full-range speaker 220c.

Specifically, the sound generator of the sixth tweeter 210c′ and the sound generator of the sixth full-range speaker 220c′ may be positioned opposite to the sound generator of the fifth tweeter 210c and the sound generator of the fifth full-range speaker 220c. By arranging the direction in which sound is output differently, more three-dimensional sound may be output.

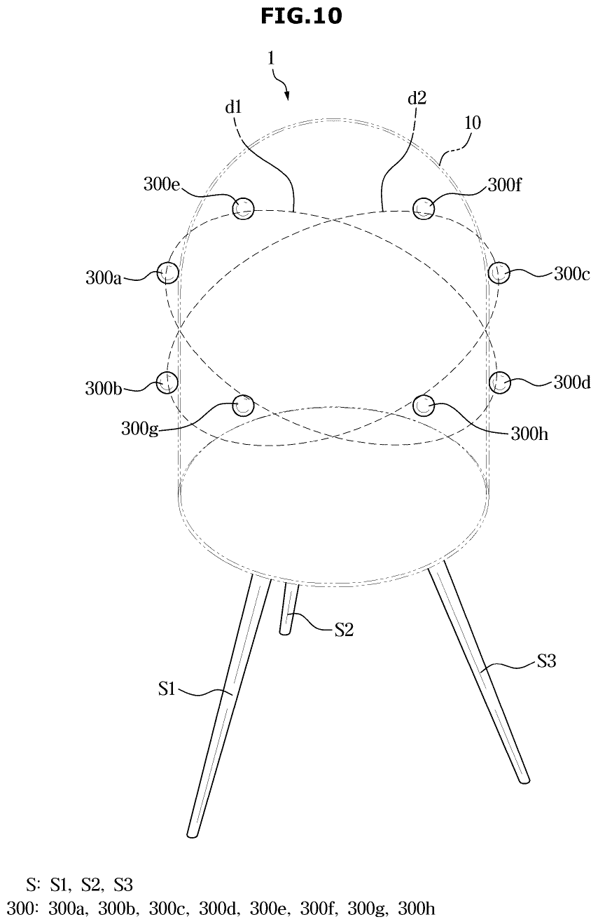

FIG. 10 is a diagram illustrating a position of the sub speaker 300 of the display apparatus 1 according to an embodiment.

The sub speaker 300 may be located on an inner or outer surface of the case 10 to output audio content. Specifically, the sub speaker 300 may output a sound whose sound image localization position changes (hereinafter, moving sound). Sound image localization refers to the position of a sound source perceived by a listener.

To this end, a plurality of sub speakers 300 may be provided. For example, the first sub speaker 300a, the second sub speaker 300b, the third sub speaker 300c, the fourth sub speaker 300d, the fifth sub speaker 300e, the sixth sub speaker 300f, the seventh sub speaker 300g, and the eighth sub speaker 300h provided. In FIG. 10, the eight sub speakers 300 are illustrated as an example, but at least two or more or more than eight sub speakers 300 may be provided to output moving sound.

The plurality of sub speakers 300 may be disposed symmetrically with respect to the projector 100 to output sound. For example, the first sub speaker 300a may be disposed symmetrically with the fourth sub speaker 300d with respect to the projector 100, and the second sub speaker 300b may be disposed symmetrically with the third sub speaker 300c with respect to the projector 100.

The plurality of sub speakers 300 may be disposed on a virtual plane. Referring to FIG. 10, the first sub speaker 300a, the fourth sub speaker 300d, the sixth sub speaker 300f, and the seventh sub speaker 300g are disposed on a first virtual plane d1, and the second sub speaker 300b, the third sub speaker 300c, the fifth sub speaker 300e, and the eighth sub speaker 300h are disposed on a second virtual plane d2. As the plurality of sub speakers 300 are disposed on the virtual planes, three-dimensional sound may be output. In FIG. 10, a case where there are two virtual planes is illustrated as an example, but there may be one or two or more virtual planes.

In addition, in a case where there are two or more virtual planes, the virtual planes may intersect each other. Referring to FIG. 10, the first virtual plane d1 may intersect with the second virtual plane d2. By arranging a plurality of virtual planes on which the plurality of sub speakers 300 are disposed to intersect each other so that moving sound is output in all directions, more three-dimensional sound may be output.

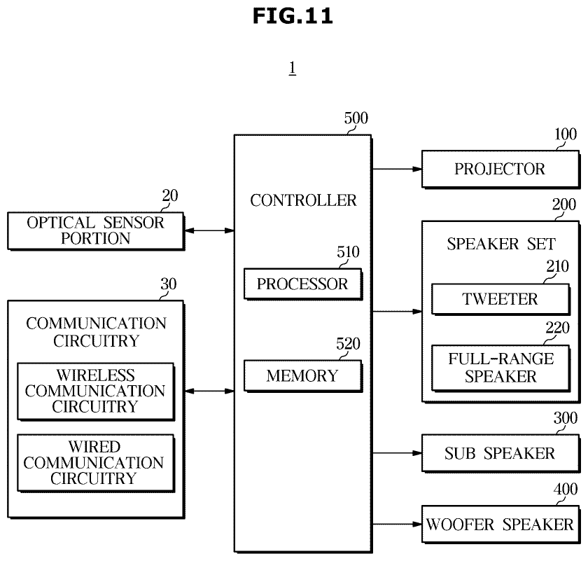

FIG. 11 is a control block diagram of the display apparatus 1 according to an embodiment.

Referring to FIG. 11, the display apparatus 1 according to an embodiment may include an optical sensor portion 20, communication circuitry 30, the projector 100, the speaker set 200, the sub speaker 300, the woofer speaker 400, and a controller 500.

The optical sensor portion 20 may include a plurality of radar sensors that may detect information about a space where the display apparatus I is located. The plurality of radar sensors may transmit an electromagnetic wave (hereinafter, a detection electromagnetic wave) to an upper side, a lower side, a right side, a left side, a front side, and a rear side of the space where the display apparatus 1 is located in order to detect the information about the space where the display apparatus 1 is located, and may receive an electromagnetic wave (hereinafter, a reflected electromagnetic wave) reflected from an object or a wall located in the space where the display apparatus 1 is located. To this end, the plurality of radar sensors may be located on an upper surface, a lower surface, a right surface, etc. of the display apparatus 1.

The plurality of radar sensors may detect a phase difference (or time difference) between the detection electromagnetic wave and the reflected electromagnetic wave, and may output information about the phase difference (or time difference) detected by each radar sensor to the controller 500.

However, the configuration of the optical sensor portion 20 is not limited to the above-described example, and may include any means and methods capable of detecting spatial information of the space where the display apparatus 1 is located. For example, the optical sensor portion 20 may include a camera.

The communication circuitry 30 may transmit data to an external device or receive data from an external device under the control of the controller 500. For example, the communication circuitry 30 may communicate with a server and/or a user terminal and/or a home appliance to transmit and receive various data.

To this end, the communication circuitry 30 may establish a direct (e.g., wired) communication channel or a wireless communication channel between external electronic devices (e.g., a server, a user terminal, and/or a home appliance) and support the communication through the established communication channel. According to an embodiment, the communication circuitry 30 may include wireless communication circuitry (e.g., a cellular communication module, a short-range wireless communication module, or a global navigation satellite system (GNSS) communication module) or a wired communication circuitry (e.g., a local area network (LAN) communication module, or a power line communication module).

Among these communication modules, the corresponding communication module may communicate with an external device through a first network (e.g., a short-range wireless communication network such as Bluetooth, wireless fidelity (Wi-Fi) direct, or infrared data association (IrDA)) or a second network (e.g., a long-range wireless communication network such as a legacy cellular network, a 5G network, a next-generation communication network, the Internet, or a computer network (e.g., LAN or WAN)). These various types of communication modules may be integrated into one component (e.g., a single chip) or may be implemented as a plurality of separate components (e.g., a plurality of chips).

According to various embodiments, the communication circuitry 30 may establish communication with a user terminal through a server.

In various embodiments, the communication circuitry 30 may include a Wi-Fi module, and may perform communication with an external server and/or a user terminal based on the establishment of communication with an access point (AP) in the home.

The projector 100 may output video content on which image processing has been performed by the controller 500. The configuration of the projector has been described above.

The speaker set 200, the sub speaker 300, and the woofer speaker 400 may output audio content on which audio signal processing has been performed by the controller 500. The configuration of the speaker set 200, the sub speaker 300, and the woofer speaker 400 has been described above.

The controller 500 may include a processor 510 that generates a control signal related to the display apparatus 1, and a memory 520 that stores a program, an application, an instruction, and/or data for the operation of the display apparatus 1. The processor 510 and the memory 520 may be implemented as separate semiconductor devices or as a single semiconductor device. In addition, the controller 500 may include a plurality of processors 510 or a plurality of memories 520.

The controller 500 may be provided at various locations inside the display apparatus 1. For example, the controller 500 may be included in a printed circuit board provided in the projector 100.

The processor 510 may include an arithmetic circuit, a memory circuit, and/or a control circuit. The processor 510 may include a single chip or a plurality of chips. In addition, the processor 510 may include a single core or a plurality of cores.

The memory 520 may store a program for controlling the components of the display apparatus 1 according to a user command, and data about spatial information detected by the optical sensor portion 20. In addition, the memory 520 may store data about a method of controlling the speaker set 200 and the sub speaker 300 according to a moving sound.

The memory 520 may include volatile memory, such as static random access memory (S-RAM) or dynamic random access memory (D-RAM), and non-volatile memory, such as read only memory (ROM) or erasable programmable read only memory (EPROM). The memory 520 may include one memory device or a plurality of memory devices.

The processor 510 may process data and/or a signal using a program provided from the memory 520, and may transmit a control signal to each component of the display apparatus I based on the processing result.

For example, the processor 510 may perform audio signal processing on audio content received from the communication circuitry 30 and transmit a control signal to allow sound to be output from the speaker set 200, the sub speaker 300, and the woofer speaker 400.

According to an embodiment, the processor 510 may process spatial information received from the optical sensor portion 20, and may determine a point at which sound arrives within the space based on the processed spatial information.

In addition, the processor 510 may control the speaker set 200 to output sound to the determined point.

According to an embodiment, the processor 510 may control the speaker set 200 and the sub speaker 300 according to a moving sound.

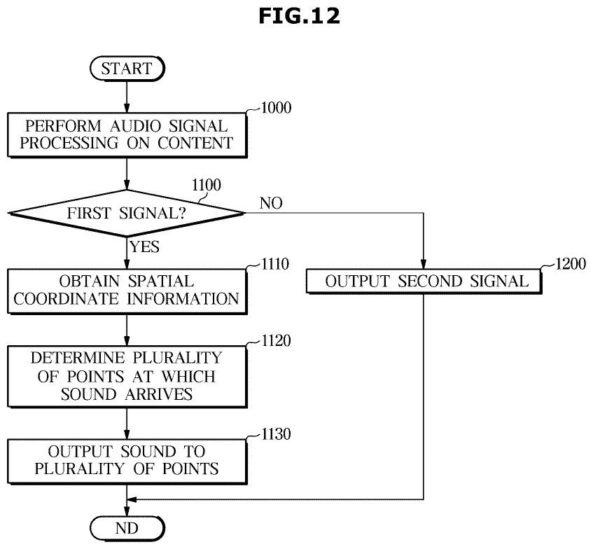

FIG. 12 is a flowchart illustrating a control method of the display apparatus 1 according to an embodiment.

Referring to FIG. 12, the display apparatus 1 may perform audio signal processing on audio content received from an external device (1000). Specifically, the processor 510 may process content data and/or a signal received from the communication circuitry 30 using a program provided from the memory 520.

The processor 510 may perform signal processing on the audio content received from the communication circuitry 30 by decoding or transcoding to separate the processed audio content into a first signal with a fixed sound image localization and a second signal with a moving sound image localization.

The processor 510 may additionally classify the first signal based on a position of the sound image localization. For example, the processor 510 may classify the first signal into a left channel, a center channel, a right channel, a surround-left channel, and a surround-right channel.

The processor 510 may control the speaker set 200 to output sound corresponding to the first signal, in a case where the audio content subjected to the audio signal processing is the first signal (Yes in operation 1100).

Specifically, the processor 510 may control the speaker set 200 based on spatial information.

To this end, the processor 510 may obtain spatial coordinate information by processing the spatial information received from the optical sensor portion 20 (1110).

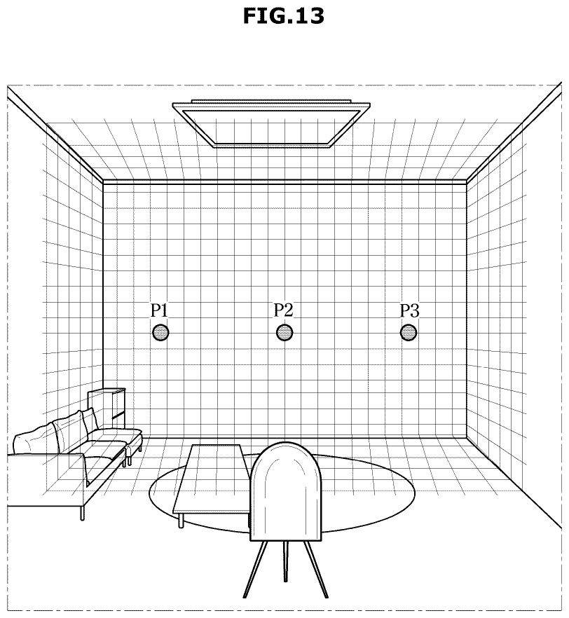

An exemplary process of obtaining spatial coordinate information and an exemplary process of controlling the speaker set 200 based on the spatial coordinate information are described with reference to FIG. 13.

FIG. 13 is a diagram illustrating that the processor 510 of the display apparatus 1 according to an embodiment determines a sound output position.

The processor 510 may determine coordinates corresponding to the space where the display apparatus 1 is located based on information about a phase difference detected by each radar sensor, and may store the determined spatial information in the memory 520. Here, the information about a phase difference may be received from the plurality of radar sensors.

In addition, the processor 510 may determine a plurality of points at which the sound output from the speaker set 200 arrives based on the determined spatial coordinate information (1120). Referring to FIG. 13, the processor 510 may determine a first point P1 at which a left channel arrives, a second point P2 at which a center channel arrives, and a third point P3 at which a right channel arrives based on the determined spatial coordinate information.

For example, the processor 510 may determine the point at which the left channel arrives by calculating an average value of coordinates on the left side based on the display apparatus 1, may determine the point at which the right channel arrives by calculating an average value of coordinates on the right side based on the display apparatus 1, and may determine the point at which the center channel arrives by calculating an average value of the point at which the left channel arrives and the point at which the right channel arrives.

The processor 510 may control the plurality of speaker sets 200 to output sound to the determined plurality of points (1130).

Specifically, the processor 510 may determine a frequency of the output sound based on a distance to the plurality of points, a position of a user, and the like. By allowing the user to perceive sound reflected from the plurality of points, the sound image localization may be clearly conveyed to the user.

The processor 510 may control the sub speaker 300 to output a moving sound according to the second signal (1200), in a case where the audio content subjected to the audio signal processing is the second signal (No in operation 1100).

Specifically, the processor 510 may control the sub speaker 300 based on spatial information. To this end, the processor 510 may obtain spatial coordinate information by processing the spatial information received from the optical sensor portion 20. As described above, the processor 510 may determine the coordinates corresponding to the space where the display apparatus 1 is located based on the information about a phase difference detected by each radar sensor. Here, the information about a phase difference may be received from the plurality of radar sensors.

The processor 510 may control the sub speaker 300 to output the moving sound by processing the second signal based on the determined coordinate information of the space.

Specifically, the processor 510 may control the sub speaker 300 to output the moving sound by performing panning processing on the second signal based on a vector of the space.

According to an embodiment, the processor 510 may control the speaker set 200 and the sub speaker 300 to output the moving sound by processing the second signal based on the determined coordinate information of the space.

The disclosed embodiments may be implemented in the form of a recording medium that stores instructions executable by a computer. The instructions may be stored in the form of program codes, and when executed by a processor, the instructions may create a program module to perform operations of the disclosed embodiments. The recording medium may be implemented as a computer-readable recording medium.

The computer-readable recording medium may include all kinds of recording media storing instructions that may be interpreted by a computer. For example, the computer-readable recording medium may be a read only memory (ROM), a random access memory (RAM), a magnetic tape, a magnetic disk, a flash memory, an optical data storage device, etc.

Although embodiments of the disclosure have been described with reference to the accompanying drawings, a person having ordinary skilled in the art will appreciate that other specific modifications may be easily made without departing from the technical spirit or essential features of the disclosure. Accordingly, the foregoing embodiments should be regarded as illustrative rather than limiting in all aspects.

According to an embodiment of the disclosure, a display apparatus 1 may include: a case 10; a projector 100 disposed in the case 10 and configured to output video content; and a speaker set 200 disposed between the case 10 and the projector 100, wherein the speaker set is configured to output audio content, wherein the speaker set 200 may include a tweeter 210 and a full-range speaker 220 disposed adjacent to the tweeter 210.

The display apparatus 1 may further include a plurality of speaker sets 200, and a portion of the plurality of speaker sets 200 may be disposed symmetrically with respect to the projector 100.

The tweeter 210 and the full-range speaker 220 each may include: a sound generator configured to generate sound; and a guide tube including a plurality of radiation holes for outputting the sound. According to the disclosure, directional sound may be output.

The plurality of radiation holes may be arranged along a longitudinal direction of the guide tube.

The full-range speaker 220 may be disposed to allow radiation holes of the full-range speaker 220 to be arranged in the same direction as radiation holes of the tweeter 210. According to the disclosure, a decrease in sound quality may be suppressed by outputting sound across all frequency bands.

The speaker set 200 may include: a first tweeter 210a, a first full-range speaker 220a which is installed to allow radiation holes of the first full-range speaker 220a to be arranged in the same direction as radiation holes of the first tweeter 210a, a second tweeter 210a′ which may be disposed to allow radiation holes of the second tweeter 210a′ to be arranged in a different direction from the radiation holes of the first tweeter 210a, and a second full-range speaker 220a′ which is installed to allow radiation holes of the second full-range speaker 220a′ to be arranged in the same direction as the radiation holes of the second tweeter 210a′. According to the disclosure, more three-dimensional sound may be provided by outputting sound from a plurality of directions.

The second tweeter 210a′ and the second full-range speaker 220a′ may be disposed to allow the radiation holes of the second tweeter 210a′ and the second full-range speaker 220a′ to be arranged in a direction opposite to the radiation holes of the first tweeter 210a.

The display apparatus 1 may include a second tweeter 210a′ configured to output the sound in a direction opposite to a sound output direction of a first tweeter 210a. According to the disclosure, more three-dimensional sound may be provided by disposing a speaker with different sound output direction.

The display apparatus 1 may further include a plurality of sub speakers 300 positioned an outer surface of the case 10. According to the disclosure, more three-dimensional sound may be provided by outputting a moving sound.

The plurality of sub speakers 300 may be disposed on a virtual plane.

A plurality of virtual planes may be provided and the plurality of virtual planes may intersect each other. According to the disclosure, more three-dimensional sound may be output by arranging the plurality of sub speakers 300 on a plurality of virtual planes that intersect each other and outputting a moving sound in all directions.

According to an embodiment of the disclosure, a display apparatus 1 may include: a case 10; a projector 100 disposed in the case 10 and configured to output video content; a speaker set 200 disposed between the case 10 and the projector 100 and configured to output sound that outputs audio content; and a plurality of sub speakers 300 positioned an outer surface of the case 10, wherein the speaker set 200 may include a tweeter 210 and a full-range speaker 220 disposed adjacent to the tweeter 210, the plurality of sub speakers 300 may be disposed on a virtual plane, and a plurality of virtual planes may be provided and the plurality of virtual planes may intersect each other. According to the disclosure, more three-dimensional sound may be output by arranging the plurality of sub speakers 300 on a plurality of virtual planes that intersect each other and outputting a moving sound in all directions.

According to an embodiment of the disclosure, a display apparatus 1 may include: a case 10; a projector 100 disposed in the case 10 and configured to output video content; a speaker set 200 disposed between the case 10 and the projector 100 and configured to output sound that outputs audio content; a sub speaker 300 positioned an outer surface of the case 10; and a processor 510 configured to perform signal processing on the audio content, separate the processed audio content into a first signal with a fixed sound image localization and a second signal with a moving sound image localization, and control the speaker set 200 and the sub speaker 300 based on the first signal and the second signal. According to the disclosure, more three-dimensional sound may be output by separating and outputting the audio content into a first signal and a second signal.

The processor 510 may be configured to control the speaker set 200 to output the sound based on the first signal.

The display apparatus 1 may further include: an optical sensor portion 20 configured to obtain spatial information, wherein the processor 510 may be configured to determine a plurality of points at which the sound arrives within a space based on the spatial information, and control the speaker set 200 to output the sound to the plurality of points.

The processor 510 may be configured to control the speaker set 200 and the sub speaker 300 to output the sound based on the second signal.

The display apparatus 1 may further include: an optical sensor portion 20 configured to obtain spatial information, wherein the processor 510 may be configured to determine a vector of the space based on the spatial information, and control the sub speaker 300 to output the sound by performing panning processing on the second signal based on the vector of the space.

What is claimed is:

1. A display apparatus comprising:
a case;
a projector disposed in the case and configured to output video content; and
a speaker set disposed between the case and the projector, and configured to output audio content,
wherein the speaker set comprises at least one tweeter and at least one full-range speaker adjacent to the at least one tweeter.

2. The display apparatus of claim 1, further comprising a plurality of speaker sets comprising the speaker set,
wherein at least two speaker sets of the plurality of speaker sets are disposed symmetrically with respect to the projector.

3. The display apparatus of claim 1, wherein each of the at least one tweeter and the at least one full-range speaker comprises:
a sound generator configured to generate sound; and
a guide tube comprising a plurality of radiation holes configured to output the sound.

4. The display apparatus of claim 3, wherein the plurality of radiation holes of the guide tube of the at least one tweeter is arranged along a longitudinal direction of the guide tube of the at least one tweeter, and the plurality of radiation holes of the guide tube of the at least one full-range speaker is arranged along a longitudinal direction of the guide tube of the at least one full-range speaker.

5. The display apparatus of claim 3, wherein the at least one full-range speaker and the at least one tweeter are disposed so that the plurality of radiation holes of the guide tube of the at least one full-range speaker is arranged in a same direction as the plurality of radiation holes of the guide tube of the at least one tweeter.

6. The display apparatus of claim 3, wherein the at least one tweeter comprises a first tweeter and a second tweeter,
wherein the at least on full-range speaker comprises a first full-range speaker and a second full-range speaker,
wherein the first tweeter and the first full-range speaker are disposed so that the plurality of radiation holes of the guide tube of the first full-range speaker is arranged in the same direction as the plurality of radiation holes of the guide tube of the first tweeter,
wherein the second tweeter is disposed so that the plurality of radiation holes of the guide tube of the second tweeter is arranged in a different direction from the plurality of radiation holes of the guide tube of the first tweeter, and
wherein the second full-range speaker is disposed so that the plurality of radiation holes of the guide tube of the second full-range speaker is arranged in a same direction as the plurality of radiation holes of the guide tube of the second tweeter.

7. The display apparatus of claim 6, wherein the second tweeter and the second full-range speaker are disposed so that the plurality of radiation holes of the guide tube of the second tweeter and the plurality of radiation holes of the guide tube of the second full-range speaker is arranged in a direction opposite to the plurality of radiation holes of the guide tube of the first tweeter.

8. The display apparatus of claim 3, the at least one tweeter comprises a first tweeter and a second tweeter, and the second tweeter is configured to output the sound in a direction opposite to a sound output direction of the first tweeter.

9. The display apparatus of claim 1, further comprising:
a plurality of sub speakers positioned on an outer surface of the case.

10. The display apparatus of claim 9, wherein the plurality of sub speakers is disposed on a virtual plane.

11. The display apparatus of claim 9, wherein the plurality of sub speakers is disposed on a plurality of virtual planes, and
wherein the plurality of virtual planes intersect each other.

12. A display apparatus comprising:
a case;
a projector disposed in the case and configured to output video content;
a speaker set disposed between the case and the projector and configured to output sound associated with audio content; and
a plurality of sub speakers positioned on an outer surface of the case,
wherein the speaker set comprises a tweeter and a full-range speaker adjacent to the tweeter,
wherein the plurality of sub speakers is disposed on a plurality of virtual planes, and
wherein the plurality of virtual planes intersect each other.

13. The display apparatus of claim 12, wherein each of the tweeter and the full-range speaker comprises:
a sound generator configured to generate sound; and
a guide tube comprising a plurality of radiation holes configured to output the sound.

14. A display apparatus comprising:
a case;
a projector disposed in the case and configured to output video content;
a speaker set disposed between the case and the projector, and configured to output sound associated with audio content;
at least one sub speaker positioned on an outer surface of the case; and
a processor configured to perform signal processing on the audio content, separate the processed audio content into a first signal with a fixed sound image localization and a second signal with a moving sound image localization, and control the speaker set and the at least one sub speaker based on the first signal and the second signal.

15. The display apparatus of claim 14, wherein the processor is further configured to control the speaker set to output the sound based on the first signal.

16. The display apparatus of claim 15, further comprising:
an optical sensor portion configured to obtain spatial information,
wherein the processor is configured to determine a plurality of points at which the sound arrives within a space based on the spatial information, and control the speaker set to output the sound to the plurality of points.

17. The display apparatus of claim 14, wherein the speaker set comprises a tweeter and a full-range speaker adjacent to the tweeter,
wherein the tweeter comprises a plurality of radiation holes, and
wherein the full-range speaker comprises a plurality of radiation holes.

18. The display apparatus of claim 14, wherein the at least one sub speaker is disposed on a virtual plane.

19. The display apparatus of claim 14, wherein the at least one sub speaker comprises a plurality of sub speakers is disposed on a plurality of virtual planes, and
wherein the plurality of virtual planes intersect each other.

20. The display apparatus of claim 14, wherein the output sound is three-dimensional sound.
